(19) United States
(12) Patent Application Publication
(10) Pub. No.: US 2018/0275072 A1
(43) Pub. Date: Sep. 27, 2018

(54) SUBSTRATE TESTING CARRIER AND SUBSTRATE TESTING DEVICE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Shufeng Wang, Beijing (CN); Jing Wang, Beijing (CN); Peng Zhao, Beijing (CN)

(21) Appl. No.: 15/793,881

(22) Filed: Oct. 25, 2017

(30) Foreign Application Priority Data
Mar. 24, 2017 (CN) 201710183166.5

(51) Int. Cl. G01N 21/84; G02F 1/13; G02F 1/1335

(52) U.S. Cl. CPC G01N 21/84; G01N 2021/8477; G02F 1/133602; G02F 1/1309

(57) ABSTRACT

A substrate testing carrier and a substrate testing device are provided. The substrate testing carrier includes: a carrier body, the carrier body including a transparent carrying plate for placing a substrate to be tested, the transparent carrying plate including a first surface configured to be in contact with the substrate to be tested; at least one backlight source arranged at a side of the transparent carrying plate away from the first surface; a moving mechanism connected to the at least one backlight source and configured to move the at least one backlight source.

### CROSS-REFERENCE TO RELATED APPLICATION

The present application claims priority to Chinese patent application No. 201710183166.5 filed on Mar. 24, 2017, the disclosure of which is incorporated herein in its entirety by reference.

### TECHNICAL FIELD

The present disclosure relates to the field of testing technology, and more particularly to a substrate testing carrier and a substrate electric testing device.

### BACKGROUND

In the related art, a liquid crystal display screen usually includes an array substrate and a color filter substrate, and it is commonly required that a mother board of the array substrate is subjected to an electric test using an electric testing device. In general, when testing the mother board of the array, first, a plurality of backlight sources is distributed on a substrate testing carrier of the electric testing device, and a sample to be tested is placed at an appropriate location on the substrate testing carrier to ensure that a backlight source is provided at a location where the sample is to be tested, after that, a test probe is moved to the location where the sample is to be tested, and then the test probe is pressed down to ensure that the test probe is in good contact with a test point on the sample so as to test the sample.

In the related art, in order to facilitate subjecting different or different locations of the sample to the electric test, the plurality of backlight sources is distributed on the substrate testing carrier of the electric testing device, for example, 24 backlight sources in a square shape, each with an area of about 36 square centimeters, these backlight sources are embedded into the substrate testing carrier, and locations of these backlight sources are fixed.

During a practical test, since there is only one test probe that works at a time, accordingly, there is only one backlight source that works at a time, this results in a waste of other backlight sources. In addition, since there exist differences of brightness uniformity among backlight sources, in the case that testing is implemented at different locations of a large board of array substrate or a same sample is placed at different locations and tested repeatedly, actual illumination intensities from backlight sources at different locations will be different when subjecting the same sample to the test under some illumination intensity (e.g., 3500 nits), and there will result in different test results.

### SUMMARY

An object of the present disclosure is to provide a substrate testing carrier and a substrate testing device, thus facilitating a test and improving efficiency and accuracy.

The technical solution provided by the present disclosure is as follows.

A substrate testing carrier includes a carrier body comprising a transparent carrying plate for carrying a substrate to be tested, the transparent carrying plate comprising a first surface being in contact with the substrate to be tested; at least one backlight source arranged at a side of the transparent carrying plate away from the first surface; and a moving mechanism for moving the at least one backlight source.

Furthermore, the moving mechanism includes a first moving unit for moving the backlight source in a first direction; and a second moving unit for moving the backlight source in a second direction; the first direction and the second direction being perpendicular to each other.

Furthermore, the first moving unit includes a first guide rail extending along the first direction; a first sliding member being moveable on the first guide rail, the backlight source being arranged on the first sliding member; and a first driving member for driving the first sliding member to move on the first guide.

Furthermore, the second moving unit includes a second guide rail and a third guide rail being arranged in parallel and extending in the second direction, two ends of the first guide rail being connected with a second sliding member and a third sliding member respectively, the second sliding member being configured to move on the second guide rail, and the third sliding member being configured to move on the third guide rail; and a second driving member for driving the second sliding member and the third sliding member.

Furthermore, the second moving unit includes a second guide rail and a third guide rail being arranged in parallel and extending in the second direction, two ends of the first guide rail being connected with a second sliding member and a third sliding member respectively, the second sliding member being configured to move on the second guide rail, and the third sliding member being configured to move on the third guide rail; and a second driving member for driving the second sliding member and a third driving member for driving the third sliding member.

Furthermore, the carrier body is of a box structure having an inner cavity, the backlight source is arranged in the inner cavity of the box structure.

Furthermore, the second guide rail and the third guide rail are arranged in parallel at two sides of the substrate testing carrier opposite to each other.

Furthermore, a plurality of vacuum suction pores for fixing the substrate to be tested by suction is distributed on the first surface; a plurality of gas passages corresponding to the plurality of vacuum suction pores respectively is arranged inside the transparent carrying plate; a plurality of gas passage exits corresponding to the plurality of vacuum suction pores respectively is arranged at a pre-determined location of the transparent carrying plate, and the gas passage exits are communicated with a vacuum pump; wherein one end of each gas passage is communicated with a vacuum suction pore corresponding to the gas passage, another end of the gas passage is communicated with the gas passage exit corresponding to the vacuum suction pore, and each of the vacuum suction pores is capable of being independently controlled.

Furthermore, the transparent carrying plate further includes a second surface opposite to the first surface; and a side surface formed between the first surface and the second surface; wherein the pre-determined location of the transparent carrying plate is the side surface of the transparent carrying plate.

Furthermore, the plurality of vacuum suction pores is at least arranged in a preset region on the first surface of the transparent carrying plate and in an array form.

A substrate testing device includes a test probe and the above-described substrate testing carrier.

Furthermore, the substrate testing device further includes a controlling mechanism connected to the test probe and the substrate testing carrier, the controlling mechanism being capable of controlling the test probe and the backlight source to move synchronously.

Furthermore, the substrate testing device further includes a computer, a controller and a semiconductor parameter analyzer.

Furthermore, the controller is configured to convert pin assignment, and connects the substrate testing carrier and the computer to realize a correct matching between a software pin assignment and a physical pin assignment.

Furthermore, the semiconductor parameter analyzer is configured to provide a scanning signal and collect and process required voltage signals and current signals.

Furthermore, the computer coordinates the controller, the semiconductor parameter analyzer and the substrate testing carrier using a test software, and presents signals collected by the semiconductor parameter analyzer.

### BRIEF DESCRIPTION OF THE DRAWINGS

FIG. 1 is a schematic view showing a structure of a substrate testing carrier according to at least one embodiment of the present disclosure;

FIG. 2 is a schematic view showing a structure of a substrate testing device according to at least one embodiment of the present disclosure.

### DETAILED DESCRIPTION

In order to make the objects, the technical solutions and the advantages of the present disclosure more apparent, the technical solutions of the embodiments of the present disclosure will be described hereinafter in a clear and complete manner in conjunction with the drawings of the embodiments of the present disclosure. Obviously, the following embodiments are merely a part of, rather than all of, the embodiments of the present disclosure, and based on these embodiments, a person skilled in the art may obtain other embodiments, which also fall within the scope of the present disclosure.

For the problem in the related art that the plurality of backlight sources is fixed on the substrate testing carrier, and the difference between backlight sources influences the accuracy of test and the like, the present disclosure provides a substrate testing carrier and a substrate testing device, and backlight sources may be moved, thus facilitating test and improving efficiency and accuracy of the test.

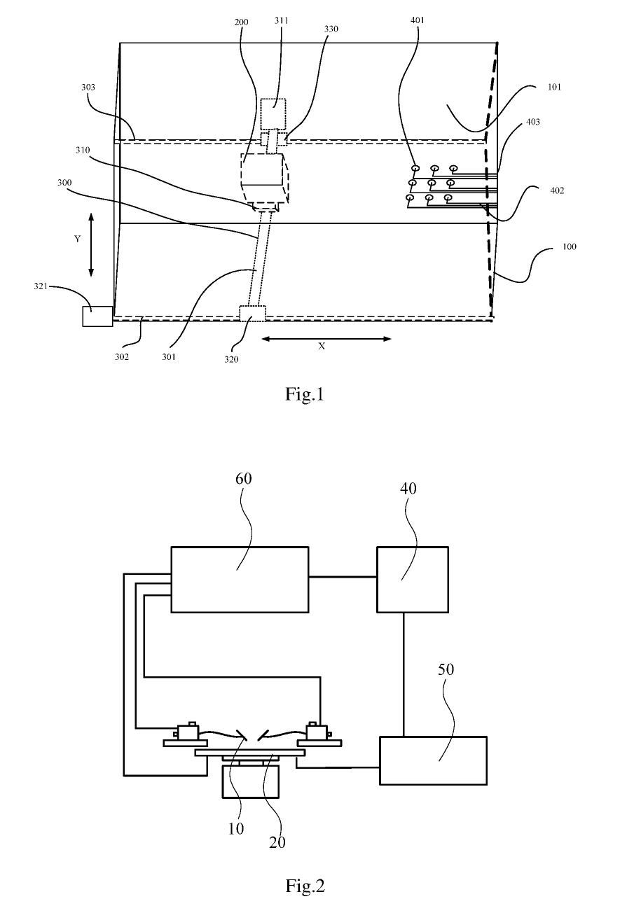

As shown in FIG. 1, the substrate testing carrier provided by embodiments of the present disclosure includes a carrier body 100 including a transparent carrying plate 101 for placing a substrate to be tested, the transparent carrying plate including a first surface for carrying the substrate to be tested; at least one backlight source 200 arranged at a side of the transparent carrying plate opposite to the first surface; and a moving mechanism 300 connected to the backlight source 200 and configured to move the backlight source 200.

The backlight source 200 of the substrate testing carrier provided by the present disclosure may moves to an appropriate location according to practical requirements to provide the substrate to be tested with backlight, as compared with a manner in the related art where the backlight source 200 is fixed on the carrier, a tester may have variety of and more convenient options when placing a test substrate, and there will be no cases where the placed substrate is not provided with backlight, which greatly facilitates the test and improves the efficiency of the test. Meanwhile, the quantity of backlight sources 200 required by the substrate testing carrier is greatly reduced, and the cost is decreased. In addition, the test may be performed by moving a same backlight source 200 to different locations, which avoids a difference of test results caused by the difference between different backlight sources 200, thus improving an accuracy of the test result.

Optional embodiments of the substrate testing carrier provided by the present disclosure in at least one embodiment are described hereinafter.

As shown in FIG. 1, in an embodiment according to the present disclosure, the moving mechanism 300 includes: a first moving unit for moving the backlight source 200 in a first direction (a Y direction); and a second moving unit for moving the backlight source 200 in a second direction (an X direction), wherein the first direction (the Y direction) and the second direction (the X direction) are perpendicular to each other.

By adopting the above solution, the moving mechanism may move the backlight source 200 back and forth on a plane parallel to the transparent carrying plate 101 in the first direction (the Y direction) and the second direction (the X direction) perpendicular to each other, such that the backlight source 200 may be moved to any coordinate position of the transparent carrying plate 101 and below the substrate to be tested, so as to provide the substrate to be tested with backlight.

In an embodiments according to the present disclosure, as shown in FIG. 1, the first moving unit includes: a first guide rail 301 extending in the first direction (the Y direction); a first sliding member 310 which is moveable on the first guide rail 301, the backlight source 200 being arranged on the first sliding member 310; and a first driving member 311 for driving the first sliding member 310 to move on the first guide rail 301. The second moving unit includes: a second guide rail 302 and a third guide rail 303 which are arranged in parallel and extend in the second direction (the X direction), two ends of the first guide rail 301 being connected with a second sliding member 320 and a third sliding member 330 respectively, the second sliding member 320 being configured to move on the second guide rail 302, and the third sliding member 330 being configured to move on the third guide rail 303; and a second driving member 321 for driving the second sliding member and the third sliding member.

Optionally, the second sliding member and the third sliding member may also be driven by different driving members.

Optionally, the second guide rail 302 and the third guide rail 303 are arranged in parallel at two sides of the substrate testing carrier opposite to each other.

In the above solution, optional embodiments of the first moving unit and the second moving unit are provided, by moving the second sliding member 320 and the third sliding member 330 on the second guide rail 302 and the third guide rail 303 respectively, and optionally, the second sliding member 320 and the third sliding member 330 may be moved synchronously, to realize a movement of the backlight source 200 in the first direction (the Y direction); by moving the first sliding member 310 on the first guide rail 301, a movement of the backlight source 200 in the second direction (the X direction) is realized, thus accomplishing movements of the backlight source 200 in any directions, which is simple in structure, and easy to control, thus to enable the backlight source 200 to be moved to any coordinate position of the transparent carrying plate 101 and below the substrate.

It should be understood that, a specific structure of the moving mechanism is not limited to this, and in practical applications, the specific structure of the moving mechanism is not limited.

In an embodiment according to the present disclosure, as shown in FIG. 1, the carrier body 100 is of a box structure having an inner cavity, and the backlight source 200 is arranged in the inner cavity of the box structure.

In the above solution, the carrier body 100 may be of a hollow box structure, the moving mechanism and the backlight source 200 may be installed at a bottom of the box structure, thus, when testing the substrate to be tested, the tester may place the substrate to be tested on the transparent carrying plate 101 of the carrier body 100, and may automatically control the first driving member and the second driving member through a controlling mechanism or manually control the first driving member and the second driving member, to move the backlight source 200 to below the substrate to be tested and provide the substrate to be tested with backlight.

In addition, in a substrate testing device in the related art, during practical tests, the sample to be tested commonly needs to be firmly fixed on a surface of the substrate testing carrier to ensure that the sample to be tested is in good contact with the surface of the substrate testing carrier. If the sample to be tested is not in good contact with the substrate testing carrier, the sample to be tested will be slightly moved up and down or in left and right directions when a test probe is pressed to a test point after positioning a test point on the sample to be tested, resulting in offset between the test probe and the test point, and influencing the accuracy of a test result or failing to get the test result. In the existing substrate testing carrier, a suction loop is arranged only at an outer ring of each backlight source, the test sample may be adsorbed only when an area of the sample is capable of covering the suction loop at the outer ring of the backlight source completely, which has no effect when testing a large board of array substrate, and will not result in a case where the sample cannot be fixed by vacuum suction. However, when analyzing defects of the sample in laboratories, sample testing is implemented for a single display screen or a part of a screen, and the samples are often small in size and irregular in shape, even if a whole display screen is subjected to the test, although the sample to be tested is large enough, testing point locations are often located at corners of the display screen, in this case, it cannot be ensured that the sample to be tested may be fixed by vacuum suction and a backlight source is provided at the testing point locations at the same time, which makes the test very inconvenient.

For the above problem, in an embodiment according to the present disclosure, as shown in FIG. 1, the transparent carrying plate 101 includes a first surface configured to be in contact with the substrate to be tested, a plurality of vacuum suction pores 401 distributed on the first surface and used for fixing the substrate to be tested by suction; a plurality of gas passages 402 arranged inside the transparent carrying plate 101 and corresponding to a plurality of vacuum suction pores 401 respectively; a plurality of gas passage exits 403 arranged at predetermined locations of the transparent carrying plate 101 and corresponding to the plurality of vacuum suction pores 401 respectively. The gas passage exits 403 are communicated with a vacuum pump. One end of each gas passage 402 is communicated with a vacuum suction pore 401 corresponding to the gas passage 402, another end of the gas passage 402 is communicated with the gas passage exit 403 corresponding to the vacuum suction pore 401, and a working condition of each vacuum suction pore 401 is capable of being independently controlled.

By adopting the above solution, the transparent carrying plate 101 on the box structure of the carrier body may be a whole piece of glass or other transparent plates covering the box structure, the vacuum suction pores 401 may be prearranged on the first surface of the transparent carrying plate 101, the gas passage 402 is inside the transparent carrying plate 101, and finally each of the vacuum suction pores 401 is connected to the vacuum pump through the gas passage 402, the gas passage 402 is a round hole-shaped passage in the transparent carrying plate 101, and is connected to a side wall of the box structure through an edge of transparent carrying plate 101, thus finally being connected with the vacuum pump. Since each of the vacuum suction pores 401 may be independently controlled, vacuum suction and fixations of any irregularly shaped samples may be conveniently realized, thus improving the problem in the related art that the substrate testing carrier may fix only a square or rectangular substrate to be tested having a certain area, in addition, since the substrate testing carrier adopts the transparent carrying plate 101, by utilizing the gate passage of the vacuum suction pore 401 arranged inside the transparent carrying plate 101, the substrate to be tested may be fixed by vacuum suction without influencing bottom backlight to the substrate to be tested, which greatly enriches test conditions.

Optionally, as shown in FIG. 1, the transparent carrying plate 101 further includes: a second surface opposite to the first surface; and side surfaces formed between the first surface and the second surface. The plurality of gas passage exits 403 are arranged at a side surface of the transparent carrying plate 101.

By adopting the above solution, the gas passage 402 may be connected to the vacuum pump at the side surface of the transparent carrying plate 101 without any impact to the first surface of the transparent carrying plate 101. It should be understood that, in practical applications, a specific shape of the gas passage 402 and the gas passage exit 403 may further have other arranging manner, the above are merely the optional embodiments of the present disclosure, which will not be limited herein.

In addition, in embodiments according to the present disclosure, optionally, as shown in FIG. 1, the plurality of vacuum suction pores 401 are distributed in an array form in at least one pre-determined region on the first surface of the transparent carrying plate 101.

By adopting the above solution, for the case in laboratories where the substrate testing carrier usually needs to be adopted for testing a small-sized substrate, considering practical test situations in the laboratories, the plurality of vacuum suction pores 401 is arranged in an array form in the pre-determined region on the transparent carrying plate 101, the vacuum suction pores 401 distributed in the pre-determined region may satisfy test requirements in the laboratories to fix the different shapes of substrates by vacuum suction. Optionally, the pre-determined region is close to a corner of the transparent carrying plate 101, which is convenient for the tester to place the substrate to be tested, and makes a length of the gas passage 402 short. Obviously, it should be understood that, a specific quantity and a manner of distribution of the vacuum suction pores 401 are not limited herein.

In addition, as shown in FIG. 2, the present disclosure further provides in at least one embodiment a substrate testing device, including a test probe 10 and the above-described substrate testing carrier 20. Optionally, the substrate testing device further includes a controlling mechanism connected to the test probe 10 and the substrate testing carrier 20, the controlling mechanism is capable of controlling the test probe to move synchronously with the backlight source 200.

By adopting the above solution, when testing the substrate to be tested, the tester places the substrate to be tested on the surface of the transparent carrying plate 101, and may control the test probe to be moved to an appropriate location using the controlling mechanism, while the test probe moves, the backlight source 200 also performs a similar movement following the test probe, such that the backlight source 200 will always be kept below the test probe so as to provide backlight to the substrate to be tested. Obviously, it should be understood that, the test probe and the backlight source 200 may also be individually controlled.

A testing process of the substrate testing device provided by the present disclosure in at least one embodiment is described hereinafter.

As an example, it is assumed that the substrate to be tested is an array substrate, the array substrate is provided with a plurality of gate lines, a plurality of data lines and thin film transistors (TFTs), each of the TFTs has three electrodes, that is, a gate electrode, a source electrode and a drain electrode. When performing the test, the array substrate is placed at an appropriate location on the substrate testing carrier, and then the test probe and the backlight source 200 are moved such that backlight source 200 moves to below the array substrate, a microscope is used to observe a relative location between the test probe and a certain electrode of the TFT, and then the test probe is pressed to ensure that the test probe is in good contact with the electrode, and further ensure an accuracy of a test result, after the three electrodes of the TFT are in complete contact with the test probe of the device, the test is accomplished by controlling a test software using a computer.

The substrate testing device mainly includes four components, that is, a computer 40, a controller 50, a semiconductor parameter analyzer 60 and a substrate testing carrier 20. The substrate testing carrier 20 mainly serves to carry a substrate to be tested, and make an electrode to be tested to be connected with the test probe. The computer 40, the controller 50 and the semiconductor parameter analyzer 60 compose a controlling mechanism. The controller 50 mainly accomplishes a conversion of pin assignment, and connects the substrate testing carrier 20 and the computer 40 to realize a correct matching of a software pin assignment and a physical pin assignment. The semiconductor parameter analyzer 60 is a main device accomplishing an electrical test of the array substrate, and is configured to provide a scanning signal and collect and process required voltage signals and current signals. The computer 40 cooperatively accomplishes a test work by coordinating other three devices using the test software, and presents the signal collected by the semiconductor parameter analyzer 60 in a concise form.

The above are merely the optional embodiments of the present disclosure, and it should be noted that, a person skilled in the art may make improvements and modifications without departing from the technical principle of the present disclosure, and these improvements and modifications shall also fall within the scope of the present disclosure.

What is claimed is:

1. A substrate testing carrier, comprising:
a carrier body comprising a transparent carrying plate for carrying a substrate to be tested, the transparent carrying plate comprising a first surface being in contact with the substrate to be tested;
at least one backlight source arranged at a side of the transparent carrying plate away from the first surface; and
a moving mechanism for moving the at least one backlight source.

2. The substrate testing carrier according to claim 1, wherein the moving mechanism comprises a first moving unit for moving the backlight source in a first direction; and a second moving unit for moving the backlight source in a second direction; the first direction and the second direction being perpendicular to each other.

3. The substrate testing carrier according to claim 2, wherein the first moving unit comprises:
a first guide rail extending along the first direction;
a first sliding member being moveable on the first guide rail, the backlight source being arranged on the first sliding member; and
a first driving member for driving the first sliding member to move on the first guide rail.

4. The substrate testing carrier according to claim 3, wherein the second moving unit comprises:
a second guide rail and a third guide rail being arranged in parallel and extending in the second direction, two ends of the first guide rail being connected with a second sliding member and a third sliding member respectively, the second sliding member being configured to move on the second guide rail, and the third sliding member being configured to move on the third guide rail; and
a second driving member for driving the second sliding member and the third sliding member.

5. The substrate testing carrier according to claim 3, wherein the second moving unit comprises:
a second guide rail and a third guide rail being arranged in parallel and extending in the second direction, two ends of the first guide rail being connected with a second sliding member and a third sliding member respectively, the second sliding member being configured to move on the second guide rail, and the third sliding member being configured to move on the third guide rail; and
a second driving member for driving the second sliding member and a third driving member for driving the third sliding member.

6. The substrate testing carrier according to claim 1, wherein the carrier body is of a box structure having an inner cavity, and the backlight source is arranged in the inner cavity of the box structure.

7. The substrate testing carrier according to claim 4, wherein the second guide rail and the third guide rail are arranged in parallel at two sides of the substrate testing carrier opposite to each other.

8. The substrate testing carrier according to claim 1, wherein a plurality of vacuum suction pores for fixing the substrate to be tested by suction is distributed on the first surface; a plurality of gas passages corresponding to the plurality of vacuum suction pores respectively is arranged inside the transparent carrying plate; a plurality of gas passage exits corresponding to the plurality of vacuum suction pores respectively is arranged at a pre-determined location of the transparent carrying plate, and the gas passage exits are communicated with a vacuum pump; wherein one end of each gas passage is communicated with a respective vacuum suction pore corresponding to the gas passage, another end of the gas passage is communicated with the gas passage exit corresponding to the respective vacuum suction pore, and each of the vacuum suction pores is capable of being independently controlled.

9. The substrate testing carrier according to claim 8, wherein the transparent carrying plate further comprises a second surface opposite to the first surface; and a side surface formed between the first surface and the second surface; wherein the pre-determined location of the transparent carrying plate is the side surface of the transparent carrying plate.

10. The substrate testing carrier according to claim 8, wherein the plurality of vacuum suction pores is at least arranged in a preset region on the first surface of the transparent carrying plate and in an array form.

11. A substrate testing device comprising a test probe and a substrate testing carrier, wherein the substrate testing carrier comprises:
a carrier body comprising a transparent carrying plate for carrying a substrate to be tested, the transparent carrying plate comprising a first surface being in contact with the substrate to be tested;
at least one backlight source arranged at a side of the transparent carrying plate away from the first surface; and
a moving mechanism for moving the at least one backlight source.

12. The substrate testing device according to claim 11, further comprising:
a controlling mechanism connected to the test probe and the substrate testing carrier, the controlling mechanism being configured to control the test probe and the backlight source to move synchronously.

13. The substrate testing device according to claim 11, further comprising a computer, a controller and a semiconductor parameter analyzer.

14. The substrate testing device according to claim 13, wherein the controller is configured to convert pin assignments, and connects the substrate testing carrier and the computer to realize a correct matching between a software pin assignment and a physical pin assignment.

15. The substrate testing device according to claim 13, wherein the semiconductor parameter analyzer is configured to provide a scanning signal and collect and process required voltage signals and current signals.

16. The substrate testing device according to claim 13, wherein the computer coordinates the controller, the semiconductor parameter analyzer and the substrate testing carrier using test software, and presents signals collected by the semiconductor parameter analyzer.
